(19) United States
(12) Patent Application Publication
(10) Pub. No.: US 2002/0101604 A1
(43) Pub. Date: Aug. 1, 2002

(54) METHOD FOR CAUSING PRINTER SYSTEM TO PERFORM PRINTING, PRINTING METHOD, COMPUTER, AND PRINTER SYSTEM

(76) Inventors: YOSHIAKI MIMA, MUAASHINO-SHI (JP); KAZUYA KOSAKA, SAGAMIHARA-SHI (JP)

Correspondence Address: RONALD L DRUMHELLER, 94 TEAKETTLE SPOUT ROAD, MAHOPAC, NY, 10541

(21) Appl. No.: 09/152,240

(22) Filed: Sep. 11, 1998

(30) Foreign Application Priority Data
Sep. 12, 1997 (JP) 9-248440

(51) Int. Cl. B41J 1/00

(52) U.S. Cl. 358/1.15

(57) ABSTRACT

In order to provide a method for enabling the combination of a plurality of printer systems to perform parallel printing in an environment where a plurality of printers are connected to a network, when a request for printing a document is to be output to the printers, a document monitoring process is performed for each document. In the document monitoring process, the conditions of the currently available printer resources are examined, and for optimal performance of the printing request, a document to be printed is divided into a plurality of printing jobs. The division of the document into a plurality of printing jobs can cope with various requests for optimization, such as a reduction in turn-around time. The printing job is a program for managing the printing of each page, such as printing “from page x to page y” of a document, and monitors the performance of the document printing process. By using this program, a different procedure can be employed for each printing job. When a printing job agent is received by the printer monitor, a program defined in the printing job agent is changed to an executable form by the printer monitor. When no malfunction occurs at the printer, the program of the printing job agent initiates the printing of a designated document, and then notifies the source that the printing has completed normally.

### BACKGROUND OF THE INVENTION

1. Field of the Invention

The present invention relates to a printing process, and more particularly to an application of a mobile agent technology to a printing process.

2. Related Art

It is possible that computers and printers are connected together via a network, and one or more computers share one or more printers. In this network, each printer has an ID, and the computers employ the IDs to issue print requests to the printers. Generally, the printer has a spooling function that temporarily stores requests (printing jobs) from the computers, and that performs printing jobs sequentially as soon as the mechanical part of the printer is ready. By this function, a plurality of documents can be printed with the shortest idle time of the printer.

When the above system executes a print request, the printing job is allocated to a specific printer until the beginning of the printing. The allocation of the printing job can be altered only by a user. Malfunctions, such as paper jams and the lack of paper, ink or toner, from which recovery is not possible by electronic means, frequently occur in the printers. When such a malfunction has occurred, the printer system does nothing but halt the job, and no process is provided that would permit another printer to continue the printing. Therefore, the performance of a printing job allocated to the printer in which the malfunction occurred must wait until the recovery action for the malfunction is taken by an operator.

When one or more documents constituted by an enormous quantity of data are to be output, the simultaneous employment of a plurality of printers can reduce the total processing; however, current print controllers do not automatically perform such parallel printing. To perform parallel printing with a currently available system, an application program or a user must precisely designate printing jobs for individual printers, and this imposes a load on the user or the application program.

Since a computer at an intermediate level or higher that can control a plurality of printers can assign a new printing job to the printer that has the least load, the operation rate of the printers can be improved. This is a very effective control method if using high-speed, reliable printers.

However, in the current office environment, a plurality of small, low-speed and less reliable printers are provided for the personal use. In this environment, optimal use of printers is not always attained by allocating a specific printing job to a specific printers. The use of a conventional printing control method gives rise to a counterproductive and ineffective use of resources, where one printing job occupies one specific printer for a long time, while many printers connected to a network stand idle.

### SUMMARY OF THE INVENTION

It is, therefore, one object of the present invention to provide a method whereby, in an environment where a plurality of printers are connected to a network, if a malfunction occurs at a specific printer, another printer is automatically selected to perform printing.

It is another object of the present invention to provide a method for enabling a combination of printers to perform parallel printing in an environment where a plurality of printers are connected to a network.

It is an additional object of the present invention to provide a method for employing a mobile agent technology to perform printing.

According to the present invention, when a request for printing a document is to be output to a printer, a process called as a document monitor is performed for each document. The document monitor examines the conditions of the currently available printer resources, and divides a document to be printed into a plurality of printing jobs to optimize the printing request. The division of the document into a plurality of printing jobs can cope with various requests for optimization, such as a reduction in turn-around time, an increase in printing throughput, the optimization of print quality and the avoidance of malfunctions. The printing job is a program for managing the printing of each page, such as printing “from page x to page y” of a document, and for monitoring the performance of the document printing process. This program allows each printing job to do a different procedure.

The specific procedures are as follows. An execution environment of mobile agents, which is called a printer monitor and corresponds to a printer, is executed on the printer on a computer associated with the printer. The printer monitor is coupled to the printer via a communication means, and can transmit print data and commands to the printer, and can examine the state of the printer. By periodically checking the state of the printer, it can transmit data concerning the state via a network to another process. With this function, a computer on the network can always acquire the states of printers, such as “in which printer a paper jam has occurred,” and “which printer is still printing and how many more sheets it has to print.” In the present invention, the mobile agent is the combination of a program and data, and it means an object that can move across the network.

The printer monitor can receive a printing job agent (mobile agent). When a printing job agent arrives at the printer monitor, the print monitor converts a program defined in the printing job agent into an executable form. Although the printer monitor can receive a plurality of printing job agents, only one printing job agent can issue a print request to a printer. A printing job agent, which is in the executable form and is ready to perform printing, outputs a print request to the printer, and constantly acquires the state of the printer through the printer monitor or by communicating directly with the printer.

When no malfunction occurs at the printer, the program of the printing job agent initiates the printing of a designated document, and then notifies the source that requested the printing of the normal completion. When a malfunction occurs during the printing, the program defined in the printing job agent determines the cause (contents) of the malfunction, and, as needed, notifies the source that requested the printing of the situation. For the notification, the agent may either generate a message, or may return to the source that requested the printing together with the print data and the print control data. When the agent returns to the source that requested the printing, unprinted data may be saved.

A network print monitor is installed in a computer in the network to manage global information across a network. The network print monitor acquires the state of printers by receiving a notice from a printer monitor, or by issuing a query, and monitors the performance and the status of the printers. The network print monitor has a table which records the statuses of a plurality of printers, a mechanism for receiving status notifications from printers, and a mechanism for periodically examining the statuses of the printers.

A document monitor includes print data generated when a document is to be printed. The document monitor is very effective, particularly when a document is divided into a plurality of segments for printing. This process manages printing resources as regards: how pages to be printed are divided and which printer is selected for the printing job; in what state the executing print job is; which printer can be employed and how long its waiting time is; whether color printing is available; and how much the processing capability is. The document monitor includes a table for print data and a printing job generated for each printer. The document monitor also has a function for managing and reporting which page has been output by which printer. It is possible that this process is generated, as needed, and is discarded after the document has been printed and a report of its printing has been generated.

Before printing operation, to set the printing conditions, a user selects a printing option, and in accordance with the selected option, a printer device driver generates a document monitor. The generated document monitor produces one or more printing job agents. The printing job agents are assigned by the document monitor to printers that are the most suitable for the printing job at that time, and printing is then performed by the individual printers. After the printing has been performed normally, the list of the names of printers that output the document is returned. When a malfunction has occurred, the document monitor again designates candidate printer that is to output the document, and allocates to the printer the document portion that is assumed that it has not yet been printed.

In summary of the above description, in a network connecting a plurality of printer systems and a computer, when the computer causes the printer systems to perform printing operation, first, print data and print control data relating to the print data are received. Information (e.g., information concerning job performance and printer status) relative to the plurality of printer systems is acquired. Then, the allocation of the print data to the printer systems is determined by referring to the information (the job performance and the printer status) and the print control data, and the print data are divided in accordance with the determined allocation. Following this, for each set of divided print data, a mobile agent that includes the divided print data and a print controller is generated. The mobile agent is then transmitted to a printer system to which the print data included in the mobile agent are allocated. As a result, distribution and parallel processing of the printing job can be performed. The printer system includes a set of a computer and a printer, or may be a printer incorporating a computer, which supports the direct connection with the network.

The print control data may include specifications of a print request from a user and output specifications. For example, the specifications of a print request from a user are data indicating whether color printing/monochrome printing, or high-speed printing should be performed, and the output specifications are data indicating whether printing should be done in page order 1, 2, 3, 1, 2 and 3, or 1, 1, 2, 2, 3 and 3.

In the process for generating the mobile agent, setup data of the print controller may be generated by referring to the output specifications. The above described output order is employed as setup data of the print controller, and a mobile agent instructs the output of print data in accordance with the setup data on the execution environment of the printer system.

The print controller can include a monitor for monitoring the status of the printer system; an error handler for handling an error of the printer system that the monitor reports; and a control module for controlling the output of the print data. The employment of the error handler makes it possible to automatically cope with malfunctions that frequently arise in the printer system.

At the computer, in response to receiving a notification of the print completion and confirmation of all the print completion, a print report may be generated. Means for sending an e-mail or for displaying a message on a display is employed to notify a user of the completion of the printing process, and to let the user know which printers printed which pages so that the user can easily collect the printed material. It should be noted that the print report can be generated when a malfunction has been arisen.

When the computer receives a mobile agent that includes the content of the error of the printer system and unprinted print data, a division process and a succeeding process are performed for the unprinted data. This is done because the most adequate allocation for a printing job must be performed when a printing obstacle is encountered.

In the acquiring process, from a network print monitor for holding performance data of the printer systems and for monitoring the statuses of the printer systems, the performance data and status of each printer system can be read. If a special program is provided that concentratively supervises the status data and the performance data of the printer systems, a plurality of document monitors need not individually possess the above described function.

In a similar system, a process executed by the printer system comprises the steps of: receiving a mobile agent including print data and a print controller; converting the mobile agent into an executable form; outputting the print data in accordance with the setup of the print controller; and notifying a transmission source of the mobile agent of the print completion if printing of all the print data has been completed. As a result, a document monitor can be informed that the printing has completed normally. The print controller can output print data to the printer in accordance with its own setup. The completion of the printing may be reported by the transmission of a message from the mobile agent, or by the return of the mobile agent to the document monitor.

If an error occurs in the printer system, the print controller checks a content of the error, and when the content of the error satisfies a predetermined condition, a mobile agent that includes the content of the error and unprinted print data can be transmitted to a transmission source of the mobile agent. Information concerning the content of the error and unprinted print data (or printed print data) may be transmitted as a message, or the activity of the mobile agent may be halted until recovery from the error has completed.

Following steps may be performed if a second mobile agent including print data and a print controller is received; determining whether or not a printing process for the first mobile agent has completed; and if the printing process has not completed, holding the second mobile agent in an inexecutable form. Since multiple printing processes can not simultaneously be performed by a single printer system, mobile agents are activated in order of which they arrive at the printer monitor. Mobile agents other than the active agent are halted. After the printing process of the first mobile agent completed and the mobile agent is no longer in the executable form, the second mobile agent may be returned to an executable form. When the end of the printing process is reported to the execution environment, the second mobile agent may be converted into the executable form.

Although in the above description, the present invention has been explained to be a series of processes, the present invention can be implemented as a computer system or as a local area network that includes modules for performing the various processes that are described. Further, the above described processes can be provided as a computer program that can be stored on a storage medium, such as a CD-ROM or a floppy disk, or in a storage device.

### BRIEF DESCRIPTION OF THE DRAWINGS

FIG. 1 is a diagram illustrating the general arrangement of the present invention.

FIG. 2 is a block diagram showing the structure of computer 1.

FIG. 3 is a block diagram showing the structure of a printer system 1.

FIG. 4 is a block diagram illustrating a printing job agent.

FIG. 5 is a block diagram illustrating a network printer monitor.

FIG. 6 is a flowchart showing the processing performed by the computer 1.

FIG. 7 is a flowchart showing the processing performed by a document monitor when allocating print data.

FIG. 8 is a flowchart showing the processing performed by the printer system 1.

FIG. 9 is a flowchart showing the processing performed by an error handler.

### DESCRIPTION OF THE PREFERRED EMBODIMENTS

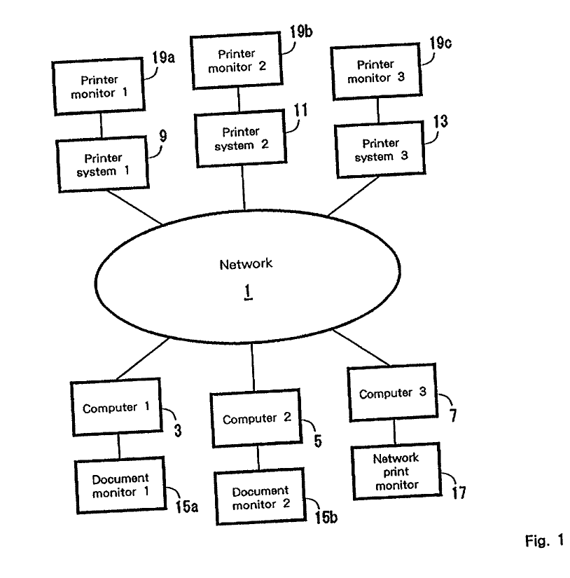

FIG. 1 is a diagram illustrating the entire system. A computer 1 (3), a computer 2 (5), a computer 3 (7), a printer system 1 (9), a printer system 2 (11) and a printer system 3 (13) are connected to a network 1. The computers 1 to 3 are ordinary computers, which include input/output devices, such as displays and keyboards, CPUs and main memories, and that execute application programs for creating documents. The computers 1 to 3 can also have secondary storage devices, such as HDDs and FDDs, CD-ROM drives, and DVD drives. Each of the printer systems 1 to 3 may be a combination of a computer and a printer, or a printer incorporating a computer that corresponds to a network. A capability, which will be described below, that provides an execution environment (a printer monitor) for a printing job agent is required for the printer systems 1 to 3. The execution environment for a mobile agent is a program for providing the computer resources and the services that are required for the activities of the mobile agent. This program includes a function for controlling the generation (activation), the freezing and the movement of a mobile agent, and holds the mobile agent and its management information as status information.

FIG. 1 also shows a document monitor 1 (15a) and a document monitor 2 (15b) that are used in the present invention, a network print monitor 17, a printer monitor 1 (19a), a printer monitor 2 (19b) and a printer monitor 3 (19c). These components are arranged and illustrated in FIG. 1 in order to describe their positional relationships, but actually, they are located in their coupled systems. That is, the document monitor 1 (15a) is located in the computer 1 (3); the document monitor 2 (15b), in the computer 2 (5); the network print monitor 17, in the computer 3 (7); the printer monitor 1 (19a), in the printer system 1 (9); the printer monitor 2 (19b), in the printer system 2 (11); and the printer monitor 3 (19c), in the printer system 3 (13). The locating of the document monitors in the computers 1 to 3 is arbitrary. A network print monitor may be provided in the computer 1 or 2 or in all the computers, or a document monitor may be provided in the computer 3.

In the system shown in FIG. 1, the document monitor determines which printer system shall be used for printing the print data prepared by the computer 1 or 2, and transmits the data as a printing job agent to the selected printer system. The printer monitor provided in the printer system activates the printing job agent in order to process the printing job. When all the data have been printed, a notification that the printing has completed is transmitted to the document monitor, which is the transmission source of the printing job agent. Upon the receipt of print completion notifications from all the printing job agents, the document monitor provides for a user information concerning which pages were printed by which printers.

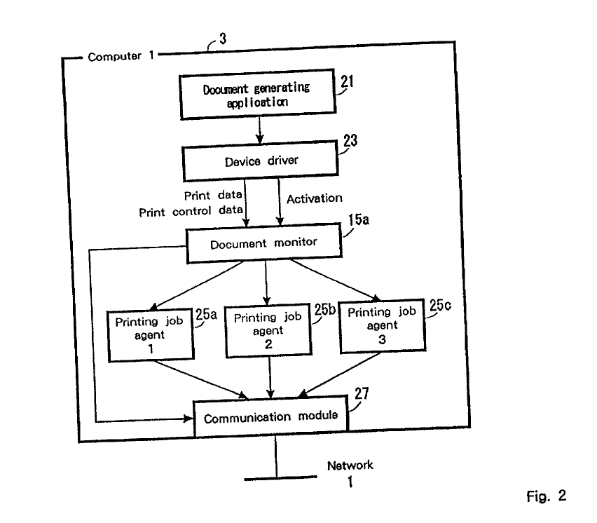

The internal arrangement of the computer 1 (3) in FIG. 1 is shown in FIG. 2. The computer 1 (3) is connected to the network 1. The computer 1 (3) includes a communication module 27 for providing a connection with the network 1, and a document generation application program 21 for generating a document to be executed. A printing device driver 23 is also provided. When a user instructs printing, document data to be printed are transmitted to the device driver 23, which activates the document monitor 15a. The device driver 23 converts the document data into print data, and transmits the print data to the document monitor 15a. The device driver 23 also outputs, as print control data to the document monitor 15a, a parameter (for example, designating color printing, fast printing or high quality printing; and how many copies should be printed and the output specifications) designated by the user for the printing of the document data. The document monitor 15a acquires information concerning the printer systems from a network print monitor 17, which will be described later, and determines the optimal allocation of the print data by the print control data for the printer systems. This process will be described later. When the data allocation is determined, printing job agents 1 to 3 (25a to 25c) are generated for individual printer systems to which print data are allocated. While only three printing job agents are shown in FIG. 2, the number of printing job agents is determined by the document monitor 15a during the allocation process. The printing job agents 1 to 3 (25a to 25c) are transmitted to the destination printer systems by means of the communication module 27.

One document monitor 15a may be provided for one computer system, or one document monitor may be generated for one printing instruction. When one document monitor is provided for one computer system, the document monitor must manage each of the printing instructions. This arrangement is also applied for the computer 2 (7).

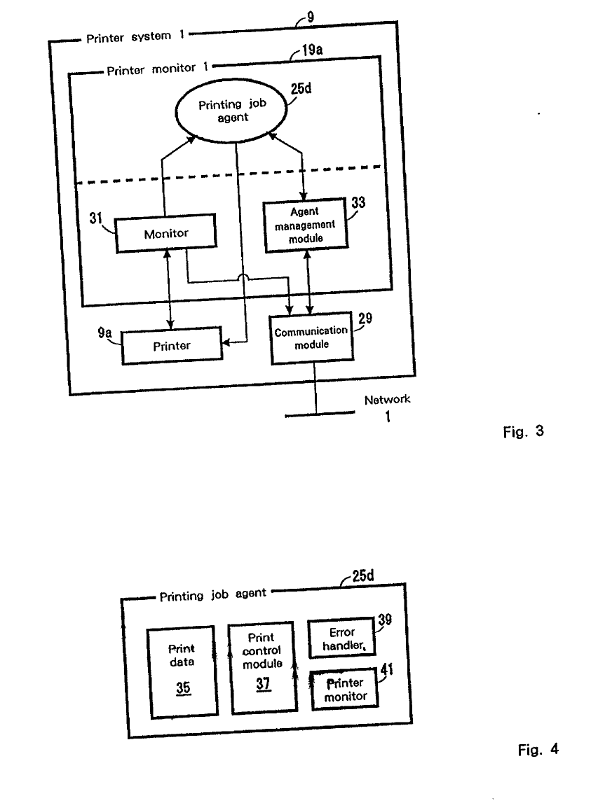

FIG. 3 is a diagram showing the internal structure of the printer system 1 (9). The printer system 1 (9) is connected to the network 1 via a communication module 29. The printer system 1 (9) has a printer monitor 1(19a) and a printer 9a. The printer monitor 1 (19a) is an execution environment of a printing job agent, and internally executes a printing job agent 25d. The printer monitor 1 (19a) includes an agent management module 33 and a monitor module 31. The printing job agent 25d arrives at the printer monitor 1 (19a) across the network 1 and through the communication module 29. The agent management module 33 performs a process for converting the received printing job agent 25d into an executable form, a process for freezing the printing job agent, and a process for, when a plurality of printing job agents are received, activating only one printing job agent, and for placing the remaining printing job agents in a queue and extracting them when they can be executed. The monitor module 31 monitors the printer 9a, and reports the results to the printing job agent 25d and the network print monitor 19. The printing job agent 25d includes a print controller, which outputs print data to the printer 9a for the actual printing of the document. The other printer systems have the same arrangement.

FIG. 4 is a block diagram illustrating the printing job agent 25d. The printing job agent 25d includes print data 35 and a print controller constituted by a print control module 37, an error handler 39 and a printer monitor 41. Primarily, the print control module 37 outputs print data to the printer, but also transmits a message when the printing has completed normally. The error handler 39 is activated when a malfunction occurs. The printer monitor 41 monitors the state of the printer 9a via the monitor module 31 in the printer monitor 1 (19a), and, as needed, relays information to the error handler 39.

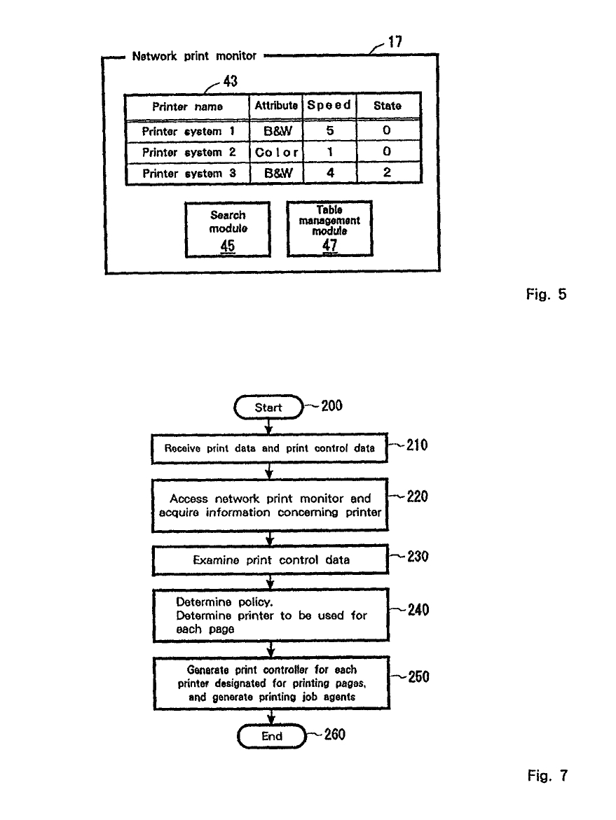

FIG. 5 is a block diagram illustrating the network print monitor 17 provided for the computer 3 (7). Since the computer 3 (7) is connected to the network 1, it has a communication module. The network print monitor 17 includes a search module 45 for responding via the communication module to a printer information search command issued by another computer; printer information 43; and a table management module 47 for managing a table storing printer information 43. As previously described, the printer monitor 19a has the monitor module 31, which transmits information to the network print monitor 19 concerning the current state of the printer 9a. The table management module 47 receives this information, and updates the printer information 43. When a new printer system is connected to the network 1, or when a printer system is removed from the network 1, a notification to that effect is sent to the table management module 47, which updates the printer information 43. The table management module 47 may periodically monitor the printer systems in the network 1. In addition, data concerning performance may be included in the printer information 43 to perform a process for predicting a turn-around time using the current processing status.

As shown in FIG. 5, the printer information 43 contains the operating state of printers (whether or not its operation is down), the color output capability, print quality (by designating the print quality), time required for outputting one page, and the quantity of a document currently scheduled for printing.

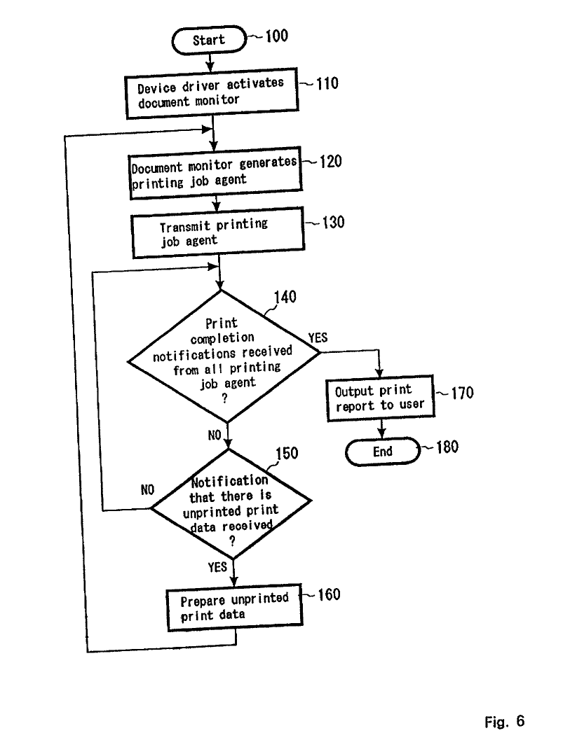

FIG. 6 is a flowchart showing the processing performed by the computer 1 (3). First, the device driver 23 of the printer activates the document monitor 15a (step 110). The document monitor 15a receives print control data and acquires information from the network print monitor 19, and determines the print data allocations. In accordance with the allocations, the document monitor 15a generates printing job agents (step 120), and transmits them (step 130).

The print monitor performs the processing for generated printing job agents, and when all the print data have been printed, the printing job agents notify the document monitor 15a of the print completion. The document monitor 15a determines whether or not it has received notifications to that effect from all the printing job agents (step 140). When the document monitor 15a has received the print completion notifications from all the printing job agents, it outputs a print report to a user (step 170). The print report may be either transmitted as an e-mail or may be output to a display by the device driver 23. For example, the data

| | | |
|---|---|---|
| printer 1 | pages | 1 to 5 |
| printer 2 | page | 6 |
| printer 3 | pages | 7 to 9 |

are provided for the user, and the user thereafter collects printed sheets distributed as indicated by the report.

If the document monitor 15a does not receive notifications from all the printing job agents, it determines whether or not it has received a notification that there is unprinted print data (step 150). If the document monitor 15a has not received such a notification, program control returns to step 140. When the document monitor 15a receives a notification that there is unprinted print data, for example, when it receives a printing job agent including unprinted print data, or when it receives a message indicating that there is unprinted print data, it prepares the unprinted print data (step 160) and program control returns to step 120, whereat a printing job agent is generated for the unprinted print data. By repeating the above process, all the print data finally is printed. It should be noted that the unprinted print data are extracted either from the printing job agent when it is returned, or from the print data held in the document monitor 15a.

The process performed by the document monitor 15a for generating printing job agents will now be described referring to FIG. 7. First, print data and print control data are received from the device driver 23 (step 210), and the network print monitor 17 is accessed to acquire the printer information 43 (step 220). That is the printer information 43 shown in FIG. 5. Then, the print control data are examined (step 230). In this case, the print control data are data such as the specifications for a print request and the designation of the output page order. The print request specifications are the print requests types that are received from the user, such as “fast printing,” “high quality printing” and “color printing,” and the designation of the output page order is the selection as to whether, when printing a plurality of copies, the same pages should be repetitively printed, or whether the printing of all the pages in order should be repeated.

The allocation policy is determined by using the print control data and information received from the network print monitor 17. Specifically, when, for example, color printing is selected, a printer whereat color printing is available is identified by using the printer information 43, and is assigned to print the pages in color. When fast printing is selected, mainly, printers that have a shorter turn-around time are selected by using the printer information 43. Since too much time will be required if all the print data are allocated to only one printer, a process may be performed for estimating the turn-around time for each allocation of pages. When high quality printing is selected, printers that can produce printed matter having a higher quality than a predetermined level are usually selected by using the printer information 43. The printers are designated for the printing of individual pages (step 240).

For each printer assigned for pages to be printed, a print controller is generated, then a printing job agent is generated (step 250). The generation of an agent is performed by preparing program code corresponding to the print controller in advance, and by setting setup information, such as the output order, which concerns the print control module, and the print data into the program code.

Assume that a system having the printer information 43 shown in FIG. 5 is to print an 8-page document, the fourth page of which is a color page, and that a print request for “color printing” and “fast printing” is issued to the system. Since “color printing” is designated, data for the fourth page is naturally allocated to Printer 2, then a printing job agent for printing the fourth page is generated. The condition is thus changed as follows (the condition of Printer2 is changed), and apparently, an output time of at least 60 seconds is required.

TABLE 1

| | Attribute | Speed | | In Process | |
|---|---|---|---|---|---|
| Printer1 | B&W | 5 | sheets/min | 0 | sheet |
| Printer2 | Color | 1 | sheet/min | 1 | sheet |
| Printer3 | B&W | 4 | sheets/min | 2 | sheets |

The time required for each printer to print n sheets is calculated as follows.

Printer1 T1=(60/5)*n1=12*n1

Printer2 T2=(60/1)*n2+(60/1)*1=60*n2+60

Printer3 T3=(60/4)*n3+(60/4)*2=15*n3+30

All the equations are represented as linear functions. The simplest determination procedure is a method whereby, assuming m sheets of the same page type are output, the three printers are examined each time they print m sheets to determine which printer outputs the sheets within the shortest period of time. Since, in this embodiment, data is output for each page, the time required for each printer is as follows.

TABLE 2

| | | | |
|---|---|---|---|
| When Printer1 is used for output, | T1 = | 12, T2 = 60, T3 | = 30 |
| | T = | max(12, 60, 30) | = 60 |
| When Printer2 is used for output, | T1 = | 0, T2 = 120, T3 | = 30 |
| | T = | max( 0, 120, 30) | = 120 |
| When Printer3 is used for output, | T1 = | 0, T2 = 60, T3 | = 45 |
| | T = | max( 0, 60, 45) | = 60 |

(T indicates the total time required for printing)

Therefore, it is appropriate for Printer 1 or Printer3 to be used for output. Assume that the faster printer of Printer1 and Printer 3 is selected and that the output of one sheet is allocated to Printer1. The output for the second sheet is calculated as follows.

TABLE 3

| | | | |
|---|---|---|---|
| When Printer1 is used for output, | T1 = | 24, T2 = 60, T3 | = 30 |
| | T = | max(24, 60, 30) | = 60 |
| When Printer2 is used for output, | T1 = | 0, T2 = 120, T3 | = 30 |
| | T = | max( 0, 120, 30) | = 120 |
| When Printer3 is used for output, | T1 = | 0, T2 = 60, T3 | = 45 |
| | T = | max( 0, 60, 45) | = 60 |

Thus, the output for a total of two sheets is allocated to Printer1. In this manner, the allocation for the output of n sheets is changed as follows.

TABLE 4

| n | ( | Printer1, | Printer2, | Printer3 | ) |
|---|---|---|---|---|---|
| 1 | ( | 1, | 0, | 0 | ) |
| 2 | ( | 2, | 0, | 0 | ) |
| 3 | ( | 3, | 0, | 0 | ) |
| 4 | ( | 4, | 0, | 0 | ) |
| 5 | ( | 5, | 0, | 0 | ) |
| 6 | ( | 5, | 0, | 1 | ) |
| 7 | ( | 5, | 0, | 2 | ) |

Finally, the printing of pages 1-3 and pages 5-6 is allocated to Printer 1, and a printing job agent is generated, and the printing of pages 7-8 is allocated to Printer 3, and a printing job agent is generated.

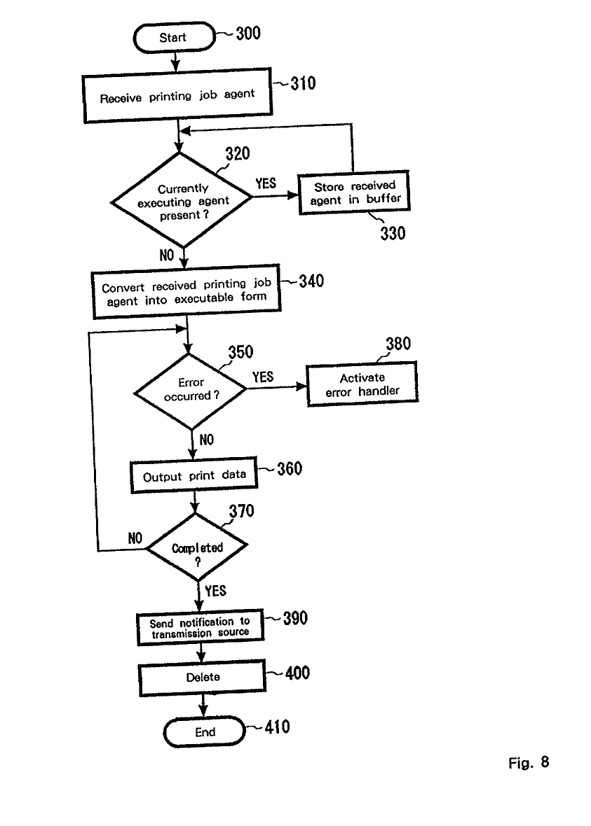

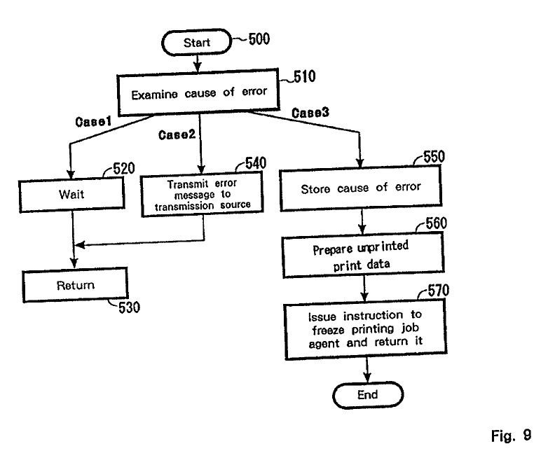

The processing performed by the printer system will now be described referring to the flowchart in FIG. 8. The printer monitor in the printer system receives a printer job agent (step 310). The agent management module 33 determines whether a printing job agent being executed is present (step 320). If such a printing job agent is present, the printing job agent that was received now is stored in a buffer without being activated (step 330). The buffer may be located in the main memory, or on a secondary storage device. The buffer is basically an FIFO buffer from which printing job agents are extracted in order of their arrival. A mechanism may be provided for assigning priorities to printing job agents and for extracting them in the priority order.

When no printing job agent being executed is present, the agent management module 33 converts the printing job agent into an executable form (step 340). The printer monitor 41 of the printing job agent examines the status of the printer to determine whether a malfunction has occurred (step 350). If a malfunction has occurred, the error handler 39 is activated (step 380). If no malfunction has occurred, print data is output to the printer 9a (step 360). When the printing is completed (step 370), notification that the printing has completed is transmitted to a transmission source (step 390). For this notification, either a message can be transmitted or the printing job agent can be returned. In this embodiment, for the notification a message is transmitted, and the printing job agent is deleted when the printing is completed (step 400). Until the printing is completed, the print monitor 41 in the printing job agent constantly monitors the printer to detect the occurrence of a malfunction. When a malfunction occurs, the error handler 39 is activated.

Example processing performed by the error handler 39 is shown in FIG. 9. When the error handler 39 is activated, the cause of a malfunction is examined upon the receipt of an error notification from the printer monitor 41 in the printing job agent (step 510). In this embodiment, the causes of the malfunctions are categorized into three cases, and the processing is varied in accordance with the case. For case 1, a situation is assumed where, for example, powering on of the printer is waited, and an error is resolved by waiting a predetermined period of time. In this case, the error handler 39 is also in the wait state (step 520), and when a predetermined period of time has elapsed, program control returns to step 350 in FIG. 8 (step 530).

For case 2, when, for example, a malfunction has occurred for which a user should immediately take recovery action, an error message is transmitted to a transmission source (step 540), and an alarm to alert the user is generated through the document monitor 15 and the device driver 23. If it is assumed that errors in case 2 and case 3 are normal errors, it is possible to set to perform switching either type of error handling in case 2 or case 3. By returning an error message to the transmission source, the document monitor of the transmission source may prepare unprinted print data and allocate to other printers the print data. At this time, the error message must include the cause of a malfunction and information concerning the print data to be printed. Case 3 is when printing should be performed by another printer system. The cause of the malfunction is stored (step 550), and unprinted print data are prepared (step 560). The data that have been printed are discarded, and the agent management module 33 is instructed to freeze the printing job agent and to return it to the transmission source (step 570). Thereafter, the agent management module 33 performs the operation as instructed. An example freezing process and an example method for converting a printing job agent into an executable form are described in “Pickling State in the Java Systems,” (The 2nd USENIX Conference on Object-Oriented Technologies, 1996). The present invention has been described, using the above embodiment, but the present invention is not limited to the above embodiment. Further, in this embodiment, when a malfunction occurs in the printer system, the printing job agent is returned to the document monitor at the transmission source. However, instead of this, an error message may be transmitted to the document monitor, which can in turn reallocate print data and designate a subsequent destination printer monitor by transmitting a message. In addition, in accordance with the message from the document monitor, a printing job may be divided by the printer monitor of a printer system in which a malfunction has occurred. The document monitor, the printer monitor, the printing job agent and the network print monitor in FIGS. 2 to 5 can be divided into arbitrary modules. In addition to the above modular divisions, the modules can be separated or united as to have the above described functions.

### ADVANTAGES OF THE INVENTION

A method can be provided whereby, in an environment where a plurality of printers are connected to a network, when a malfunction occurs at a specific printer, another printer is automatically selected to perform printing.

Furthermore, a method for enabling a combination of a plurality of printer systems to perform parallel printing can be provided in an environment where a plurality of printers are connected to a network.

In addition, a method can be provided for employing a mobile agent technology to perform printing.

1. A method for causing a plurality of printer systems to perform printing operation by a computer in a network, said network including said plurality of printer systems and said computer, said method comprising the steps of:
receiving print data and print control data relating to said print data;
acquiring information concerning said plurality of printer systems;
determining allocation of said print data to said printer systems by referring to said information concerning said plurality of printer systems and said print control data, and dividing said print data in accordance with said determined allocation;
for each set of divided print data, generating a mobile agent including said divided print data and a print controller; and
transmitting said mobile agent to a printer system to which the print data included in said mobile agent are allocated.

2. The method according to claim 1, wherein said print control data includes specifications of a print request from a user and output specifications.

3. The method according to claim 2, wherein said step of generating a mobile agent includes a step of generating setup data for said print controller by referring to said output specifications.

4. The method according to claim 1, wherein said print controller comprises:
a monitor for monitoring the status of said printer system;
an error handler for handling an error of the printer system that said monitor reports; and
a control module for controlling the output of said print data.

5. The method according to claim 1, further comprising the steps of:
receiving a notification of a print completion; and
generating a print report in response to confirmation of all the print completion.

6. The method according to claim 1, further comprising the steps of:
receiving a mobile agent including the content of the error of the printer system and unprinted print data; and
performing the allocation determining step and succeeding stops for said unprinted print data.

7. The method according to claim 1, wherein said acquiring step comprises the step of:
reading information concerning said plurality of printer systems from a network print monitor that holds performance data of said printer systems and monitors said statuses of said printer systems.

8. A method for printing in a printer system in a network connecting a plurality of printer systems and a computer, wherein each of said printer systems includes an execution environment of a mobile agent, said method comprising the steps of:
receiving a mobile agent that includes print data and a print controller;
converting said mobile agent into an executable form;
outputting said print data in accordance with a setup of said print controller; and
if the printing of all the print data has completed, notifying a transmission source of said mobile agent of the print completion.

9. The method according to claim 8, further comprising the steps of:
said print controller checking a content of an error if said error occurs in said printer system; and
when said content of said error satisfies a predetermined condition, transmitting to a transmission source of said mobile agent, said mobile agent including said content of said error and unprinted print data.

10. The method according to claim 8, further comprising the steps of:
receiving a second mobile agent including print data and a print controller;
determining whether or not a printing process of said mobile agent has completed; and
if said printing process has not completed, holding said second mobile agent in a inexecutable form.

11. The method according to claim 10, further comprising a step of:
converting said second mobile agent into the executable form in response to that said mobile agent is no longer in the executable form.

12. A computer for causing a plurality of printer systems connected to a network to perform printing operation, comprising:
an examination module for acquiring information concerning said plurality of printer systems;
a division module for determining the allocation of said print data to said printer systems by referring to said information concerning said plurality of printer systems and input print control data, and for dividing said print data in accordance with said determined allocation;
a module for generating, for each set of divided print data, a mobile agent including said divided print data and a print controller; and
a transmission module for transmitting said mobile agent to a printer system to which the print data included in said mobile agent are allocated.

13. The computer according to claim 12, wherein said print control data include specifications of a print request from a user and output specifications.

14. The computer according to claim 13, wherein said module for generating said mobile agent comprises:
means for generating setup data of said print controller by referring to said output specifications.

15. The computer according to claim 12, wherein said print controller comprises:
a monitor for monitoring the status of said printer system;
an error handler for handling an error of the printer system that said monitor reports; and
a control module for controlling the output of said print data.

16. The computer according to claim 12, further comprising:
a module for receiving a notification of a print completion; and
a module for generating a print report in response to confirmation of all the print completion.

17. The computer according to claim 12, further comprising:
a module for receiving a mobile agent including the content of the error of the printer system and unprinted print data; and
a module for extracting said unprinted print data from said mobile agent and inputting said print data into said division module.

18. The computer according to claim 12, wherein said examination module comprises:
means for reading information concerning said plurality of printer systems from a network print monitor that holds performance data of said printer systems and monitors said statuses of said printer systems.

19. A printer system connected to a network, said printer system comprising:
a printer monitor which is an execution environment of a mobile agent;
said printer monitor comprising:
a conversion module for converting a mobile agent including print data and a print controller into an executable form; and
a module for, if two or more mobile agents are received, holding mobile agents other than the executable mobile agent until a printing process by the executable mobile agent has completed, and for, if said printing process has completed, outputting one of said mobile agents other than the executable mobile agent to said conversion module.

20. The printer system according to claim 19, wherein said printer monitor further comprises:
a monitor module for monitoring the state of said printer system and informing said print controller of the state.

21. The printer system according to claim 19, wherein said monitor module notifies a network print monitor provided in said network of a status of said printer system to which said monitor module belongs, and said network print monitor collects information concerning a print system connected to the network.

22. A local area network comprising:
at least one computer; and
a plurality of printer systems;
wherein said computer includes:
an examination module for acquiring information concerning said plurality of printer systems;
a division module for determining the allocation of a print data to said printer systems by referring to said information concerning said plurality of printer systems and input print control data, and for dividing said print data in accordance with said determined allocation;
a module for generating, for each set of divided print data, a mobile agent including said divided print data and a print controller; and
a transmission module for transmitting said mobile agent to said printer system to which the print data included in said mobile agent are allocated,
and wherein each of said printer systems includes,
a receiving module for receiving said mobile agent;
a conversion module for converting said mobile agent into an executable form; and
a module for, if said receiving module receives two or more mobile agents, holding mobile agents other than the executable mobile agent until the executable mobile agent exists no longer, and for, if the executable mobile agent is no longer present, outputting one of said mobile agents other than the executable mobile agent into said conversion module.

23. A storage medium for storing a program, said program causing a computer to generate mobile agents for causing a plurality of printer systems to perform printing operation, said computer and said plurality of printer systems connected to a network, said program comprising the steps of:
receiving print data and print control data relating to said print data;
acquiring information concerning said plurality of printer systems;
determining the allocation of said print data to said printer systems by referring to said information concerning said plurality of printer systems and said print control data, and dividing said print data in accordance with said determined allocation; and
generating, for each set of divided print data, a mobile agent including said divided print data and a print controller.

24. The storage medium according to claim 23, said program further comprising a step of:
generating a print report in response to confirmation of all the print completion.

25. A storage medium for storing a mobile agent, said mobile agent comprising:
print data;
a monitor for monitoring the status of a printer system that print said print data;
an error handler for handling an error of said printer system that said monitor reports; and
a control module for controlling the output of said print data.

26. A storage device for storing a printing device driver, said printing device driver comprising the steps of:
activating a program that performs the steps of:
receiving print data and print control data of said print data;
acquiring information concerning a plurality of printer systems;
determining the allocation of said print data to said printer systems by referring to said information concerning said plurality of printer systems and said print control data, and dividing said print data in accordance with said determined allocation; and
generating, for each set of divided print data, a mobile agent including said divided print data and a print controller; and
outputting said print data and said print control data to said program.

27. A system, wherein a plurality of printer systems are connected to a network, said system allocating different pages in a document to said plurality of printer systems to perform parallel printing of said different pages of said document in said plurality of printer systems.
